(19) United States
(12) Patent Application Publication
(10) Pub. No.: US 2023/0048067 A1
(43) Pub. Date: Feb. 16, 2023

(54) EXPONENTIAL MODEL-BASED METHOD FOR PREDICTING TWO-DIMENSIONAL FLOW VELOCITY FIELD IN RIVER CHANNEL WITH EMERGENT VEGETATION

(71) Applicant: Sichuan University, Chengdu City (CN)

(72) Inventors: Chao Liu, Chengdu City (CN); Yuqi Shan, Chengdu City (CN)

(21) Appl. No.: 17/879,983

(22) Filed: Aug. 3, 2022

(30) Foreign Application Priority Data
Aug. 4, 2021 (CN) 202110889048.2

(51) Int. Cl. G06F 30/28; G01V 99/00

(52) U.S. Cl. CPC G06F 30/28; G01V 99/005; G06F 2111/10

(57) ABSTRACT

Provided is an exponential model-based method for predicting a two-dimensional flow velocity field in a river channel with emergent vegetation. The method comprises the following steps: (1) with a center of an upstream boundary of an emergent vegetation patch as an origin, dividing the river channel into a vegetated region and a bare channel in a direction perpendicular to a streamwise direction namely, an x direction; (2) determining a model for predicting flow velocity distribution of a two-dimensional flow velocity field in the vegetated region and the bare channel and (3) determining the flow velocity U_{y=b} at the side edge of the vegetation patch and the mean flow velocity U_{bare} over transverse profiles in a streamwise direction of the bare channel.

### CROSS REFERENCE TO RELATED APPLICATION

This patent application claims the benefit and priority of Chinese Patent Application No. 202110889048.2, filed on Aug. 4, 2021, the disclosure of which is incorporated by reference herein in its entirety as part of the present application.

### TECHNICAL FIELD

The present disclosure belongs to the field of hydraulics and river dynamics, and particularly relates to an exponential model-based method for predicting a two-dimensional flow velocity field in a river channel with emergent vegetation.

### BACKGROUND ART

Vegetation is widely found in natural rivers, wetlands and marshes, and plays an important role in changing the flow structure and sediment deposition. In a river channel, the flow velocity in a vegetated region is usually lower than that in a bare channel. This variation in flow velocity results in the exchange of mass and momentum, which further yields a flow velocity shear layer along the side edge of an emergent vegetation patch. The momentum exchange of the shear layer may affect the re-suspension of deposited sediment, which in turn affects the deposition of sediment in the vegetated region of the river channel.

In order to further study the interaction between the vegetation patch and riverbed evolution, it is necessary to know the distribution of the two-dimensional flow velocity field of a vegetated river channel. However, it is difficult to directly obtain the two-dimensional flow velocity field of a partially vegetated channel segment under natural conditions. There are a couple of reasons for this problem: most natural rivers are broad and have unstable flow velocity, and some vegetation may block out the water surface with their branches and leaves, making it hard to put detection equipment; therefore, it is hard to measure flow velocities at various points, and the precision of flow velocities can hardly be ensured even if certain flow velocities are obtained

In a laboratory, it is possible to measure the detailed two-dimensional flow velocity field in the vegetated region under the condition of steady uniform flow, but it takes a lot of time, manpower and money to complete the measurement work. Generally speaking, a vegetation patch with a width of 0.8 m and a length of 15 m is built in an experimental tank with a width of 2 m and a length of 23 m, measuring is conducted using an Acoustic Doppler Velocimeter (ADV), the sampling frequency is 50 Hz, and the sampling time of each point should be at least 150 s. Based on the measurement duration of 8 hours per day, it takes several weeks to months to measure the regional flow velocity of the vegetation patch in detail and analyze the flow structure within and around the vegetation patch.

Therefore, it is urgent for researchers and engineers to develop a simple and practical method for predicting a two-dimensional flow velocity field in a river channel with emergent vegetation, which can be applied to river ecology engineering, so as to provide a theoretical basis for further research on the evolution of a vegetation patch.

### SUMMARY

In view of the technical status that it is hard to effectively predict a two-dimensional flow velocity field in a river channel with an emergent vegetation patch by the prior art, a purpose of the present disclosure is to provide an exponential model-based method for predicting a two-dimensional flow velocity field in a river channel with emergent vegetation. The prediction method is based on the prediction model constructed by exponential function, which can predict the two-dimensional flow velocity field distribution of flow velocities in a vegetated region and a bare channel region at the same time.

In order to achieve the foregoing purpose, the present disclosure provides an exponential model-based method for predicting a two-dimensional flow velocity field in a river channel with emergent vegetation, the method including the following steps:

(1) with a center of an upstream boundary of an emergent vegetation patch as an origin, dividing the river channel into a vegetated region and a bare channel in a direction perpendicular to a streamwise direction, namely, an x direction, where the vegetated region is: l>y/b>−1, a central area of the vegetated region is: b−δₚ>y>δₚ−b, the bare channel is: B/2≥y≥b and −b≥y≥−B/2, a side edge of the vegetation patch is: y=b, b denotes half width of a vegetation patch, and B denotes half width of a river channel; and δₚ denotes a penetration distance that lateral vortexes penetrate into a patch through its side edge, and δₘ denotes a width of a mixed layer;

(2) determining a model for predicting flow velocity distribution of a two-dimensional flow velocity field in the vegetated region and the bare channel:

where the model for the vegetated region is:

$${U}_{d ( 1 )} = {U}_{veg} + ( {U}_{y = b} - {U}_{veg} ) {e}^{\frac{y - b}{{L}_{d ( veg )}}}$$

the model for the bare channel is:

$${U}_{d ( 2 )} = {U}_{bare} + ( {U}_{y = b} - {U}_{bare} ) {e}^{\frac{b - y}{{L}_{d ( bare )}}}$$

where U_{d (1)} denotes a laterally distributed flow velocity in a streamwise direction at different locations in the vegetated region, U_{d (2)} denotes a laterally distributed flow velocity in a streamwise direction at different locations in the bare channel, U_{veg} denotes a mean flow velocity over transverse profiles in a streamwise direction of the vegetated region, U_{y=b} denotes a flow velocity at the side edge of the vegetation patch, U_{bare} denotes a mean flow velocity over transverse profiles in a streamwise direction of the bare channel, L_{d (veg)} and L_{d (bare)} denote exponential decay lengths of the vegetated region and the bare channel, respectively, where

$$\frac{{L}_{d ( veg )}}{{δ}_{p}} = 0.32 \pm 0.04 , \frac{{L}_{d ( bare )}}{{δ}_{m}} = 0.64 \pm 0.14 ,$$

and the mean flow velocity U_{veg} over transverse profiles in a streamwise direction of the vegetated region can be determined by a model for predicting longitudinal flow velocity distribution in the river channel with an emergent vegetation patch; and

(3) determining the flow velocity U_{y=b} at the side edge of the vegetation patch and the mean flow velocity U_{bare} over transverse profiles in a streamwise direction of the bare channel:

the flow velocity U_{y=b} at the side edge of the vegetation patch and the mean flow velocity U_{bare} over transverse profiles in a streamwise direction of the bare channel are determined according to the following two boundary conditions:

a predicted flow velocity satisfies a flow continuity equation at the side edge of the vegetation patch:

$$\frac{\partial {U}_{veg}}{\partial y} = \frac{\partial {U}_{bare}}{\partial y} ;$$

a predicted flow velocity in the vegetated region and the bare channel satisfies a flow continuity equation: ∫₀^{b}U_{d(1)}dy+∫_{b}^{B}U_{d(2)} dy=BU₀;

where U_{d(1)} and U_{d(2)} denote laterally distributed velocities in the vegetated region and the bare channel obtained according to the prediction model in step (2), respectively, U₀ denotes a mean flow velocity at an upper stream of the river channel x<−Lᵤ, and Lᵤ denotes a flow deflection distance at an upper stream of the vegetation patch; and

once the flow velocity U_{y=b} at the edge of the vegetation patch and the mean flow velocity U_{bare} over transverse profiles in a streamwise direction of the bare channel are determined, the prediction model in step (2) can be used for predicting flow velocity distribution of the two-dimensional flow velocity field in the vegetated region and the bare channel.

According to the exponential model-based method for predicting a two-dimensional flow velocity field in a river channel with emergent vegetation, in the vegetated region, L_{d(veg)} is associated with the penetration distance δₚ, where

$${δ}_{p} = max [ 0.5 {( {C}_{d} a )}^{- 1} , 1.8 d ] , \frac{{L}_{d ( veg )}}{{δ}_{p}} = 0.32 \pm 0.04 ;$$

and in the bare channel, L_{d(bare)} is associated with the width δₘ of a mixed layer, where the mixed layer refers to a region where vortexes are generated by flow velocity exchange as flow velocities at two adjacent layers vary from each other. When the flow velocity changes from the initial flow velocity, and the flow velocity variation ΔU_{d}(=U_{bare}−U_{y=b}) reaches 90% of the initial flow velocity the distance over which the flow velocity decreases by 90% is defined as δₘ, where

$$\frac{{L}_{d ( bare )}}{{δ}_{m}} = 0.64 \pm 0.14 .$$

According to the exponential model-based method for predicting a two-dimensional flow velocity field in a river channel with emergent vegetation, when the upstream velocity U₀ (fixed value) passes through the channel segment of the vegetated region, it is divided into the mean flow velocity U_{veg} over transverse profiles in the streamwise direction of the vegetated region and the mean flow velocity U_{bare} over transverse profiles in the streamwise direction of the bare channel. In order to determine the flow velocity distribution of the two-dimensional flow velocity field in the vegetated region and the bare channel, it is required to determine the mean flow velocity U_{veg} over transverse profiles in the streamwise direction of the vegetated region in step (2), and the mean flow velocity U₀ and U_{bare} in the upper stream x<−Lᵤ of the river channel in step (3). The mean flow velocity U_{veg} over transverse profiles of the vegetated region in the streamwise direction can be determined according to the prediction model in the prior art. In the present disclosure, the mean flow velocity is determined by the prediction model U_{veg} established by Liu et al. (2020) (for details, refer to Liu C, Shan Y Q, Sun W, Yan C H, Yang K J. (An open channel with an emergent vegetation patch: Predicting the longitudinal profiles of velocities based on exponential decay. Journal of Hydrology, 582, 124429.), as hereunder mentioned:

where the model for the vegetated region is:

$${U}_{veg} = {U}_{veg ( f )} + ( {U}_{veg ( 0 )} - {U}_{veg ( f )} ) {e}^{\frac{- x}{{L}_{d ( 1 )}}} ;$$

where U_{veg} denotes a mean flow velocity over transverse profiles in a streamwise direction of the vegetated region, U_{veg(f)} denotes a mean flow velocity of a fully developed region x>L_{I} within the vegetation patch, U_{veg(0)} denotes a flow velocity at an upstream boundary x=0 of the vegetated region, L_{I} denotes a flow deflection distance within the vegetation patch, L_{d(1)} denotes an exponential decay length within the vegetated region, and L_{d(1)}/L_{I}=0.30±0.01.

The flow deflection distance L_{I} within the vegetation patch involved in the above prediction model U_{veg} can be calculated according to the empirical formula:

$${L}_{I} = ( 5.5 \pm 0.4 ) \sqrt{{( \frac{2}{{C}_{d} a} )}^{2} + {b}^{2}} ,$$

where C_{d} denotes a vegetation drag coefficient, a denotes a frontal area per canopy volume of vegetation per unit water body, and b denotes half width of the vegetation patch.

The mean flow velocity U_{veg(f)} in the fully developed region x>L_{I} within the vegetation patch involved in the foregoing prediction model U_{veg} may be determined according to the following formula:

$${U}_{veg ( f )} = \sqrt{\frac{ghS}{{C}_{f} + \frac{1 Cdah}{21 - φ}}} ,$$

where g denotes gravitational acceleration; h denotes a water depth; S denotes a water surface slope; and C_{f} denotes a bed friction coefficient.

The flow velocity U_{veg(0)} at the upstream boundary of the vegetated region involved in the above prediction model U_{veg} is determined according to the following formula:

U_{veg(0)}/U₀=1−(0.15±0.02)\sqrt{C_{d}ab};

where U₀ denotes a mean flow velocity at the upper stream x<−Lᵤ of the river channel.

The mean flow velocity U₀ at the upper stream x<−Lᵤ of the river channel involved in the above prediction model U_{veg} can be measured directly or determined according to the following formula, where Lᵤ denotes flow deflection distance at the upper stream of a vegetation patch, and the flow deflection distance Lᵤ is usually within a range of 30-50 cm.

$${U}_{0} = \sqrt{\frac{g h S}{{C}_{f}}}$$

where g denotes gravitational acceleration; h denotes a water depth; S denotes a water surface slope; and C_{f} denotes a bed friction coefficient.

The ideas of the present disclosure are as follows: the present disclosure is suitable for the river channel with an emergent vegetation patch where the flow velocity is greater than 0 cm/s, so the flow is regarded as two-dimensional, that is, variation of flow occurs only in the streamwise direction and horizontal direction (perpendicular to the streamwise direction). In the present disclosure, x and y denote the streamwise direction and the horizontal direction, respectively. The river channel with an emergent vegetation patch is divided into the following two regions in a flow perpendicular to a streamwise direction (y direction): vegetated region: 1>y/b>−1 and bare channel: B/2≥y≥b and −b≥y≥−B/2, where y=b denotes a side edge of the vegetation patch, namely an interface between the vegetated region and the bare channel.

The emergent vegetation patch in the river channel allows the flow deflect laterally from the vegetated region to the bare channel, resulting in an interior flow adjustment region (L_{I}>x>0) where the flow velocity sees exponential fall. According to the research by Rominger and Nepf (Rominger J T, Nepf H. Flow adjustment and interior flow associated with a rectangular porous obstruction. Journal of Fluid Mechanics, 2011, 680, 636-659.), the length of an internal flow adjustment region L_{I} is associated with vegetation density C_{d}a and width of vegetation patch b, where L_{I} can be estimated by the following formula:

$${L}_{I} = ( 5.5 \pm 0.4 ) \sqrt{{( \frac{2}{{C}_{d} a} )}^{2} + {b}^{2}} \qquad ( 1 )$$

where C_{d} denotes a vegetation drag coefficient (generally with a value of 1), and a denotes a frontal area per canopy volume of vegetation per unit water body (a=nd, where n denotes vegetation density, and d denotes a diameter of a single plant), and b denotes half width of the vegetation patch.

In addition to the interior flow adjustment region (x≥L_{I}), a fully developed region of flow is formed within the vegetation patch where the flow velocity tends to be constant. In the region x>L_{I}, when a shear layer is sufficiently strong, Kelvin-Helmholtz (KH for short) vortexes are formed along the edge of the vegetation patch, and KH vortexes occur when the parameter associated with the KH vortices, i.e.,

$$λ ( = \frac{{U}_{bare} - {U}_{v e g}}{{U}_{bare} + {U}_{v e g}} ) \geq 0.4 ,$$

where U_{bare} and U_{veg} denote mean flow velocities over transverse profiles in the streamwise direction of the bare channel and the vegetated region, respectively, which can be determined by a mean flow velocity in the vertical direction. The KH vortexes, once formed, enter the vegetation patch through the side edge. White and Nepf (2008) proposed the following formula to estimate the penetration distance δₚ:

δₚ=max[0.5(C_{d}a)⁻¹,1.8d] (2)

where d denotes a diameter of a single plant.

For the central region (b−δₚ>y>δₚ−b) of the vegetated region, the mean flow velocity U_{veg} over transverse profiles in the streamwise direction of the vegetated region is constant and free of affect from KH vortexes.

According to Liu et al. (Liu C, Shan Y Q, Sun W, Yan C H, Yang K J. (An open channel with an emergent vegetation patch: Predicting the longitudinal profiles of velocities based on exponential decay. Journal of Hydrology, 2020, 582, 124429.), a model for predicting a mean flow velocity U_{veg} over transverse profiles in the streamwise direction of the vegetated region is built:

within the vegetated region (x≥0),

$${U}_{v e g} = {U}_{veg ( f )} + ( {U}_{v e g ( 0 )} - {U}_{v e g ( f )} ) {e}^{\frac{- x}{{L}_{d ( 1 )}}} \qquad ( 3 )$$

where U_{veg(f)} denotes a mean flow velocity over transverse profiles in the fully developed region of flow (x>L_{I}); U₀ denotes a mean flow velocity of the upper stream x<−Lᵤ of the river channel, and Lᵤ denotes a flow deflection distance of the upper stream of the vegetation patch; U_{veg(0)} denotes a flow velocity at the upstream boundary x=0 of the vegetation patch; and L_{d(1)} denotes an exponential decay length of U_{veg(f)} within the vegetation patch, where

$$\frac{{L}_{d ( 1 )}}{{L}_{1}} = 0.30 \pm 0 \text{.01} ;$$

where in formula (3), the mean flow velocity U_{veg(f)} over transverse profiles in the fully developed region of flow (x>L_{I}) can be predicted according to the following formula:

$${U}_{veg ( f )} = \sqrt{\frac{ghS}{{C}_{f} + \frac{1 Cdah}{21 - φ}}} \qquad ( 4 )$$

where g denotes gravitational acceleration; h denotes a water depth; S denotes a water surface slope; and C_{f} denotes a bed friction coefficient.

In formula (3), the flow velocity U_{veg(0)} at the upstream boundary x=0 of the vegetation patch can be predicted according to the following formula, and is subject to non-dimension disposal together with the mean flow velocity U₀ at the upper stream x<−Lᵤ of the river channel. This method is applicable to a river channel with emergent vegetation having a vegetation parameter C_{d}ab=0-9.

$$\frac{{U}_{v e g ( 0 )}}{{U}_{0}} = 1 - ( 0.15 \pm 0.02 ) \sqrt{{C}_{d} a b} \qquad ( 5 )$$

In the bare channel, the exponential decay length L_{d(bare)} of the mean flow velocity U_{bare} over transverse profiles in the streamwise direction of the bare channel is associated with the width δₘ of the mixed layer, where δₘ is defined as the distance over which the flow velocity decreases by 90% when the flow velocity variation ΔU_{d}(=U_{bare}−U_{y=b}) reaches 90%, and

$$\frac{{L}_{d ( bare )}}{{δ}_{m}} = 0.64 \pm 0.14 .$$

In the vegetated region, the exponential decay length L_{d(veg)} of the mean flow velocity U_{veg} over transverse profiles in the streamwise direction within the vegetation patch is associated with the penetration distance δₚ,

$${δ}_{p} = max [ 0.5 {( {C}_{d} a )}^{- 1} , 1.8 d ] , \\ \frac{{L}_{d ( v e g )}}{{δ}_{ρ}} = 0.32 \pm 0.04 .$$

Therefore, on the basis of the prediction model for the mean flow velocity U_{veg} over transverse profiles in the streamwise direction of the vegetated region, and following the theoretical basis that “the emergent vegetation patch in the river channel makes the flow deflect laterally from the vegetated region to the bare channel, which yields an internal flow adjustment region (L_{I}>x>0) where flow velocity sees exponential fall”, the following models are established based on the exponential decay length L_{d(veg)} of U_{veg} within the vegetation patch and the exponential decay length L_{d(bare)} of U_{bare} in the bare channel:

where the model for the vegetated region is:

$${U}_{d ( 1 )} = {U}_{v e g} + ( {U}_{y = b} - {U}_{v e g} ) {e}^{\frac{y - b}{{L}_{d ( v e g )}}} \qquad ( 6 )$$

the model for the bare channel is:

$${U}_{d ( 2 )} = {U}_{b a r e} + ( {U}_{y = b} - {U}_{b a r e} ) {e}^{\frac{b - y}{{L}_{d ( bare )}}} \qquad ( 7 )$$

The above formulas (6) and (7) belong to the prediction models for flow velocity distribution of the two-dimensional flow velocity field in the vegetated region and the bare channel provided in the present disclosure. The flow velocity U_{y=b} at the side edge of the vegetation patch and the mean flow velocity U_{bare} over transverse profiles in a streamwise direction of the bare channel in the above formulas (6) and (7) are determined according to the following two boundary conditions:

a predicted flow velocity satisfies a flow continuity equation at the side edge of the vegetation patch:

$$\frac{\partial {U}_{v e g}}{\partial y} = \frac{\partial {U}_{bare}}{\partial y} at y = b ;$$

a predicted flow velocity in the vegetated region and the bare channel satisfies a flow continuity equation:

∫₀^{b}U_{d(1)}dy+∫_{b}^{B}U_{d(2)}dy=BU₀

where U_{d (1)} and U_{d (2)} denote laterally distributed flow velocities in the vegetated region and the bare channel obtained by the prediction model shown in formulas (6) and (7), respectively.

Once the flow velocity U_{y=b} at the edge of the vegetation patch and the flow velocity U_{bare} in the bare channel are determined, the prediction models shown in formulas (6) and (7) can be used for predicting flow velocity distribution of the two-dimensional flow velocity field in the vegetated region and the bare channel.

Compared with the prior art, the technical solutions provided by the present disclosure have the following beneficial effects:

(1) By adoption of the exponential model-based method for predicting a two-dimensional flow velocity field in a river channel with emergent vegetation, the river channel is divided into a vegetated region and a bare channel in the direction perpendicular to the streamwise direction; through the prediction model for flow velocity distribution of the two-dimensional flow velocity field in the vegetated region and the prediction model for flow velocity distribution of the two-dimensional flow velocity field in the bare channel, the two-dimensional flow velocity field prediction of the vegetated region and bare channel can be realized at the same time, which provides a theoretical basis for further study on the evolution of a vegetation patch.

(2) By adoption of the exponential model-based method for predicting a two-dimensional flow velocity field in a river channel with emergent vegetation, the model constructed for predicting longitudinal distribution of the mean flow velocity over transverse profiles in the vegetated region is an exponential function, which satisfies the law of hydrodynamics. The prediction model has high prediction precision, making it possible to obtain a two-dimensional flow velocity field closer to the real flow velocity.

(3) By adoption of the exponential model-based method for predicting a two-dimensional flow velocity field in a river channel with emergent vegetation, the two-dimensional flow velocity field over transverse profiles in the vegetated region and the bare channel can be predicted simply according to the basic parameters of river channel and vegetation patch (including width of the river channel, width of the vegetation patch, density of the vegetation patch, vegetation drag coefficient, river bed drag coefficient, etc.), without the need for any flow velocity measurement. In this way, it can not only cut down the research cost, but also apply to river channels workers cannot easily access, making it widely applied in various circumstances.

### BRIEF DESCRIPTION OF THE DRAWINGS

FIG. 1 is a schematic diagram of evolution of river flow under two cases of a river channel with emergent vegetation in its center, where b represents half width of vegetation patch, and B represents half width of the river channel.

FIG. 2 is a schematic diagram of evolution of river flow of a river channel with emergent vegetation at one side, where b represents the width of vegetation patch, and B represents the width of the river channel.

FIGS. 3A and 3B show a pictures for simulating two cases of a river channel with emergent vegetation according to an embodiment, where FIG. 3(A) shows a picture under case B1, and FIG. 3(B) shows a picture under case C1, where water flows from the bottom to the top.

FIGS. 4A, 4B and 4C are diagrams illustrating comparison between flow velocity measurements (represented by different symbols) and flow velocity prediction values (represented by solid lines) at different longitudinal (x direction) positions according to an embodiment, where FIG. 4A represents data under case B1, with ϕ=0.015; FIG. 4B represents data under case B2, with ϕ=0.023; FIG. 4C represents data under case B3, with ϕ=0.045, dotted lines represent the edge of vegetation patch, and vegetation length is not represented according to actual scale in the diagram.

FIGS. 5A and 5B are diagrams illustrating comparison between flow velocity measurements (represented by different symbols) and flow velocity prediction values (represented by solid lines) at different longitudinal (x direction) positions according to an embodiment, where FIG. 5A represents data under case C1, with ϕ=0.025; and FIG. 5B represents data under case C2, with ϕ=0.038, and dotted lines represent the edge of vegetation patch.

### DETAILED DESCRIPTION OF THE EMBODIMENTS

The technical solutions in the examples of the present disclosure are clearly and completely described below with reference to the accompanying drawings. Apparently, the described examples are merely a part rather than all of the examples of the present disclosure. All other embodiments obtained by a person of ordinary skill in the art based on the embodiments of the present disclosure without creative efforts should fall within present disclosure.

The following embodiment explains in detail the process of obtaining a two-dimensional flow velocity field of the river channel with emergent vegetation patch by the flume test and obtaining a two-dimensional flow velocity field of the river channel with emergent vegetation patch by model prediction and the results thereof.

I. Test Purpose

Measure flow velocity distribution of two-dimensional flow velocity fields for a vegetated region and a bare channel in a river channel with an emergent vegetation patch by a flume experiment, measure the detailed two-dimensional flow velocity distribution under certain cases, and compare the flow velocity distribution of the two-dimensional flow velocity fields in the vegetated region and the bare channel with the flow velocity distribution of the two-dimensional flow velocity field obtained by using the prediction model, so as to verify the accuracy of the exponential model-based method for predicting a two-dimensional flow velocity field in a river channel with emergent vegetation according to the present disclosure.

II. Test Device

Primary test devices are provided in Table 1.

TABLE 1
Flume test device with emergent vegetation patch

| Device name | Quantity | Remarks |
|---|---|---|
| Test flume | 2 | Flume 1: this flume is 23 meters long, 2 meters |
| | | wide and 1 meter high. Perforated PVC boards are |
| | | arranged in the whole river channel for the layout of |
| | | a vegetation patch. |
| | | Flume II: this flume is 13 meters long, 1 meter |
| | | wide and 1 meter high. Perforated PVC boards are |
| | | arranged in the whole river channel for the layout of |
| | | a vegetation patch. |
| Simulated emergent vegetation | 5 cases | cases B1-B3: the vegetation patch has a width of |
| patch | | 30-40 cm, a length of 3-5 m, and a water depth of |
| | | 17.8 ± 0.2, the mean flow velocity of the river |
| | | channel is 18.0 ± 0.5 cm/s, and the height of all |
| | | simulated vegetation is greater than the water depth, |
| | | cases C1-C2: the vegetation patch has a width of 33 |
| | | cm and a length of 4.5 m. The water depth under |
| | | cases Cl and C2 is 20.0 ± 0.2 cm, the mean flow |
| | | velocity under cases Cl and C2 is 16.6 ± 0.2 cm/s |
| | | and 19.1 ± 0.2 cm/s, respectively, and the height of |
| | | all simulated vegetation is greater than the water |
| | | depth. |
| Acoustic Doppler Current | 1 | Equipped support and data processing software |
| Profiler | | |

III. Test Case

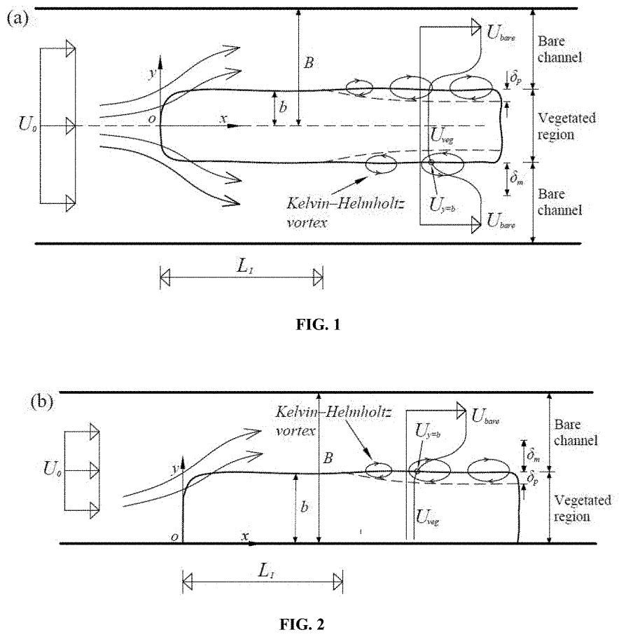

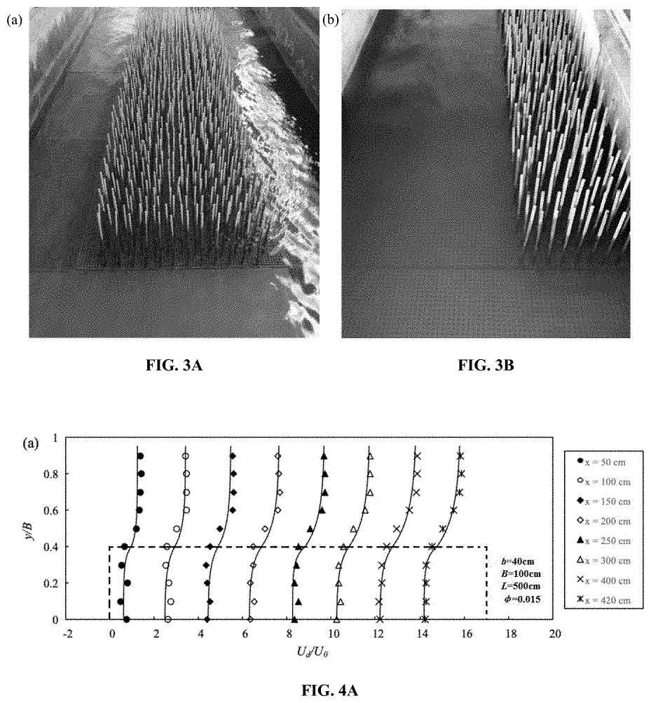

According to this embodiment, experiments are carried out on two kinds of river channels with emergent vegetation to verify the effectiveness of the prediction method provided by the present disclosure. Under one case, emergent vegetation grows at the center of the river channel, as shown in FIG. 1; and under the other case, emergent vegetation grows at one side of the river channel, as shown in FIG. 2. For this reason, a series of tests under two cases are designed and carried out in two different flumes (flume I and flume II). There is a flow straightener at the entrance of both flumes to produce a vertical and uniform flow in the flume. The water depth is adjusted by adjusting the tailgate and measured along the flume using a water gauge.

In flume I, a rectangular vegetation patch model is established and placed in the center of the flume. The rectangular vegetation patch model here does not represent a particular vegetation patch in nature, but is only designed and implemented as a generalized model. Therefore, the shape of the vegetation is not the focus of the present disclosure. Under cases B1-B3 created in flume I, a test section has a length of 15 m, and the vegetation patch has a length of L=3-5 m, where L should be greater than the flow deflection distance L_{I} within the vegetation patch, so as to reappear a fully developed region of flow (corresponding to U_{veg (f)}. Lᵤ and L_{I} are determined by the longitudinal flow velocity distribution of each case, where the distance from the position where the flow velocity at the upper stream of the vegetation patch begins to change to the front of the vegetation patch is defined as Lᵤ, and the distance from the position where the flow velocity decreases to a constant within the vegetation patch to the front of the vegetation patch is defined as L_{I}. The L_{I} values of cases B1-B3 are shown in Table 2. Under cases B1-B3, ½ of the vegetation patch has a width of b=30-40 cm, ½ of the river channel has a width of B=100 cm, and thus the ratio of the width of the vegetation patch to the width of the river channel is b/B=0.3-0.4; the water depth is h=17.8±0.2, the mean flow velocity of the river channel is U₀=18.0±0.5 cm/s, and Reynolds number is Re(=U₀R/v)≈27000, where Froude number of flow is Fr(=U₀/\sqrt{gh})=0.14, where R denotes a hydraulic radius.

In flume II, a rectangular vegetation patch model is established and placed on the side of the flume. Under cases C1-C2 created in flume II, a test section has a length of 7 m, and the vegetation patch has a length of L=4.5 m, where L should be greater than the flow deflection distance L_{I} within the vegetation patch, so as to reappear a fully developed region of flow (corresponding to U_{veg (f)}. Lᵤ and L_{I} are determined by the longitudinal flow velocity distribution of each case. The L_{I} values of cases C1-C2 are shown in Table 1. Under cases C1-C2, the vegetation patch has a width of b=33 cm, the river channel has a width of B=100 cm, and thus the ratio of the width of the vegetation patch to the width of the river channel is b/B=0.33; the water depth is h=20.0±0.2, the mean flow velocity of the river channel is U₀=19.1±0.2 cm/s, and Reynolds number is Re(=U₀R/v)≈23000−27000, where R denotes a hydraulic radius, and Froude number of flow is Fr(=U₀/\sqrt{gh})=0.12 to 0.14, which shows turbulent flow and subcritical flow both occur in the vegetation patch.

In flume I and flume II, rigid cylinders, specifically cylindrical sticks, are used to simulate vegetation. In flume I, the cylindrical emergent vegetation model has a length of 30 cm, which is greater than the water depth of 17.8 cm; and in flume II, the cylindrical emergent vegetation model has a length of 30 cm, which is greater than the water depth of 20.0 cm. Cylinders do not represent specific species of plants, but they can represent emerging vegetation such as reeds and cattails, which have hard stems. In nature, vegetation usually appears in the form of patch with limited width and length. Field studies show that the length and width of a vegetation patch are generally between 0.5 meters and 5 meters. This embodiment studies approximate two-dimensional flow formed within and around the emergent vegetation patch when the current is shallow enough. The cylindrical diameter d=0.8 cm is set based on the observed diameter range of tender plants at the river shoal and the rhizome of plants in the river (d=0.2 to 1.2 cm, Lightbody and Nepf 2006; Sand-Jensen 1998; Manners et al, 2015). The volume fraction ϕ(=π/4 nd²) of solids in the test is within a range of ϕ=0.015-0.045, which is consistent with the vegetation parameters (common gladiolus ϕ=0.001-0.04, Grace et al., 1986; Coon et al. 2000) observed by previous scholars in the field, where n denotes vegetation density per unit area of the riverbed. Specifically, ϕ=0.015, 0.023 and 0.045 under cases B1, B2 and B3, respectively, and ϕ=0.025 and 0.038 under cases C1 and C2, respectively.

The cylindrical stick is fixed on the perforated PVC board at the bottom of the flume, and the PVC board has a thickness of 1 cm. The PVC board covers the whole bed surface of the above two flumes respectively, yielding a bed friction coefficient of C_{f}=0.006±0.001. Under each case, the length of the vegetation model is larger than the interior flow adjustment distance (that is, L>L_{I}). Therefore, there are flow adjustment region and fully developed region of flow under each case. The distance L_{I} of the flow adjustment region is estimated according to the measured velocities. In the fully developed region of flow, Kelvin-Helmholtz (KH for short) vortexes occur along the side of the emergent vegetation patch. In the study of Caroppi et al. (2020), the cases for the occurrence of KH vortexes are:

$$λ ( = \frac{{U}_{bare} - {U}_{v e g}}{{U}_{bare} + {U}_{v e g}} ) \geq 0.4$$

In this embodiment, the parameter λ (=0.7 to 0.9) associated with the KH vortices is greater than the threshold (λ≥0.4), indicating that KH vortexes occur under each of the five cases of B1-B3 and C1-C2. The penetration distance δₚ of the KH vortexes is estimated by the measured laterally distributed velocities or formula (2).

As shown in FIGS. 1-2, coordinates x, y and z denote the longitudinal direction, horizontal direction and vertical direction, respectively. x=0 denotes the upstream edge of the vegetation patch model, and z=0 denotes the surface of the river bed. The definition of coordinate y varies in two cases. Specifically, for a 2 m wide flume (cases B1-B3), y=0 is the center line of the flume and the vegetation model, as shown in FIG. 1. For a 1 m wide flume (cases C1-C2), y=0 represents the side wall of the flume, as shown in FIG. 2.

The flow velocity data in two flumes are collected at the same time by using the Nortek Vectrino Acoustic Doppler Current Profiler. A downward-looking probe is fixed to half water depth of the river channel (z=h/2). Flow velocity is measured at z=h/2, as the difference between the velocity at z=h/2 in and around the emergent vegetation and the depth-averaged flow velocity U_{d} is less than 6%. In order to efficiently measure the flow velocity in the river channel, the flow velocity measured at half water depth is taken as the depth-averaged flow velocity in this embodiment. At each measuring point, the velocity is recorded for a period of 150 s at a frequency of 50 Hz. Instantaneous flow velocity data in three directions are processed by the data processing software of the Doppler Current Profiler, so as to obtain time-averaged velocities (u, v and w) in three directions x, y and z).

The longitudinal distribution of flow velocities is measured at different positions in the y direction. Within the vegetation patch model, in order to eliminate the non-uniformity of spatial flow, a characteristic region is considered at each location, that is, the flow velocity is measured at the positions of y=0 and dy/4, where dy/4 is the transverse distance between two adjacent cylindrical sticks. The probes are placed in the same orientation and at the same relative position to neighboring cylinders to minimize the measurement error induced by spatial flow heterogeneity inside the cylinder arrays. In the vegetation patch, the mean velocity at two locations in a characteristic region is defined as the depth-averaged flow velocity U_{d}; and outside the vegetation patch, the mean flow velocity at half water depth is defined as the depth-averaged flow velocity U_{d}. For cases B1-B3, the measuring positions are y=0 m, 0.1 m, 0.2 m, 0.3 m, 0.4, 0.5 m, 0.6 m, 0.7 m, 0.8 m and 0.9 m, and for cases C1 and C2, the measuring positions are y=0.05 m, 0.15 m, 0.25 m, 0.3 m, 0.35 m, 0.4 m, 0.45 m, 0.5 m, 0.55 m, 0.6 m, 0.7 m, 0.8 m and 0.9 m.

The lateral distribution of flow velocities is measured at different positions in the x direction. Specifically, for case B1, the flow velocity distributions over transverse profiles of U_{d} are measured at x=50 cm, 100 cm, 150 cm, 200 cm, 250 cm, 300 cm, 400 cm and 420 cm; for cases B2 and B3, the measurement positions are x=50 cm, 100 cm, 150 cm, 200 cm and 300 cm; and for cases C1 and C2, the measurement positions are x=50 cm, 100 cm, 150 cm, 200 cm, 250 cm, 300 cm, 350 cm, 400 cm and 450 cm. Under cases B1-B3, the vegetation model is placed in the center of the flume, so the velocity is symmetrical along the centerline of the flume and vegetation, which is confirmed by measurement. Therefore, at each x, the lateral distribution of velocity is measured only on the left side (B≥y≥0) of the vegetation patch and the river channel.

IV. Model Prediction

Flow velocity distributions of a two-dimensional flow velocity field in the vegetated region and the bare channel of the river channel with a vegetation patch are obtained through a prediction model:

(1) with a center of an upstream boundary of an emergent vegetation patch as an origin, divide the river channel into a vegetated region and a bare channel along a direction perpendicular to a streamwise direction, namely, an x direction, where the vegetated region is: 1>y/b>−1, a central area of the vegetated region is: b−δₚ>y>δₚ−b, the bare channel is: B/2≥y≥b and −b≥y≥−B/2, a side edge of the vegetation patch is: y=b, b denotes half width of a vegetation patch, and B denotes half width of a river channel; and δₚ denotes a penetration distance that lateral vortexes penetrate into a patch through its side edge;

(2) determine a model for predicting flow velocity distribution of a two-dimensional flow velocity field in the vegetated region and the bare channel:

where the model for the vegetated region is:

$${U}_{d ( 1 )} = {U}_{v e g} + ( {U}_{y = b} - {U}_{v e g} ) {e}^{\frac{y - b}{{L}_{d ( v e g )}}}$$

the model for the bare channel is:

$${U}_{d ( 2 )} = {U}_{bare} + ( {U}_{y = b} - {U}_{bare} ) {e}^{\frac{b - y}{{L}_{d ( bare )}}} ,$$

where U_{d(1)} denotes a laterally distributed flow velocity in a streamwise direction at different locations in the vegetated region, U_{d(2)} denotes a laterally distributed flow velocity in a streamwise direction at different locations in the bare channel, U_{veg} denotes a mean flow velocity over transverse profiles in a streamwise direction of the vegetated region, U_{y=b} denotes a flow velocity at the side edge of the vegetation patch, U_{bare} denotes a mean flow velocity over transverse profiles in a streamwise direction of the bare channel, L_{d(veg)} and L_{d(bare)} denote exponential decay lengths of the vegetated re ion and the bare channel, respectively, where

$$\frac{{L}_{d ( veg )}}{{δ}_{p}} = 0.32 \pm 0.04 , \frac{{L}_{d ( bare )}}{{δ}_{m}} = 0.64 \pm 0.14 ,$$

and the mean flow velocity U_{veg} over transverse profiles in a streamwise direction of the vegetated region can be determined by a model for predicting longitudinal flow velocity distribution in the river channel with an emergent vegetation patch; and

(3) determine the flow velocity U_{y=b} at the side edge of the vegetation patch and the mean flow velocity U_{bare} over transverse profiles in a streamwise direction of the bare channel.

The flow velocity U_{y=b} at the side edge of the vegetation patch and the mean flow velocity U_{bare} over transverse profiles in a streamwise direction of the bare channel are determined according to the following two boundary conditions:

a predicted flow velocity satisfies a flow continuity equation at the side edge of the vegetation patch:

$$\frac{\partial {U}_{veg}}{\partial y} = \frac{\partial {U}_{bare}}{\partial y} ;$$

a predicted flow velocity in the vegetated region and the bare channel satisfies a flow continuity equation: ∫₀^{b}U_{d(1)}dy+∫_{b}^{B}U_{d(2)} dy=BU₀;

where U_{d (1)} and U_{d (2)} denote laterally distributed velocities in the vegetated region and the bare channel obtained by the prediction model, respectively, U₀ denotes a mean flow velocity at an upper stream of the river channel x<−Lᵤ, and Lᵤ denotes a flow deflection distance at an upper stream of the vegetation patch.

Once the flow velocity U_{y=b} at the edge of the vegetation patch and the flow velocity U_{bare} in the bare channel are determined, the prediction model in step (2) can be used for predicting flow velocity distribution of the two-dimensional flow velocity field in the vegetated region and the bare channel.

For the mean flow velocity U_{veg} over transverse profiles in the streamwise direction within the vegetated region in step (2), under the five cases, U_{veg} is determined according to the following existing prediction model U_{veg}:

$${U}_{veg} = {U}_{veg ( f )} + ( {U}_{veg ( 0 )} - {U}_{v e g ( f )} ) {e}^{\frac{- x}{{L}_{d ( 1 )}}} ;$$

U_{veg(f)} denotes a mean flow velocity of a fully developed region x>L_{I} within the vegetation patch, U_{veg(0)} denotes a flow velocity at an upstream boundary x=0 of the vegetated region, L_{I} denotes a flow deflection distance within the vegetation patch, L_{d(1)} denotes an exponential decay length within the vegetated region,

$${L}_{d ( 1 )} / {L}_{I} = 0.3 \pm 0.01 ,$$

$${L}_{I} = ( 5.5 \pm 0.4 ) \sqrt{{( \frac{2}{{C}_{d} a} )}^{2} + {b}^{2}} ,$$

C_{d} denotes a vegetation drag coefficient, a denotes a frontal area per canopy volume of vegetation per unit water body, and b denotes half width of the vegetation patch (for cases C1-C2, b denotes width of the vegetation patch).

Under the five cases, the mean flow velocity U_{veg(f)} in the fully developed region within the vegetation patch involved in the foregoing prediction model U_{veg} may be determined according to the following formula:

$${U}_{v e g} ( f ) = \sqrt{\frac{g h S}{{C}_{f} + \frac{1 Cd a h}{21 - φ}}}$$

where g denotes gravitational acceleration; h denotes a water depth; S denotes a water surface slope; and C_{f} denotes a bed friction coefficient.

Under the five cases, the flow velocity U_{veg(0)} at the upstream boundary of the vegetated region involved in the above prediction model U_{veg} is determined according to the following formula:

U_{veg(f)}/U₀=1−(0.15±0.02)\sqrt{C_{d}ab};

where U₀ denotes a mean flow velocity at the upper stream of the river channel, C_{d} denotes a vegetation drag coefficient, a denotes a frontal area per canopy volume of vegetation per unit water body, and b denotes half width of the vegetation patch.

Under the five cases, the mean flow velocity U₀ at the upper stream of the river channel involved in the foregoing prediction model U_{veg} can either be determined according to the existing formula, or obtained by measurement. In this embodiment, U₀ data are obtained via actual measurement, and U₀ under each case is shown in Table 2.

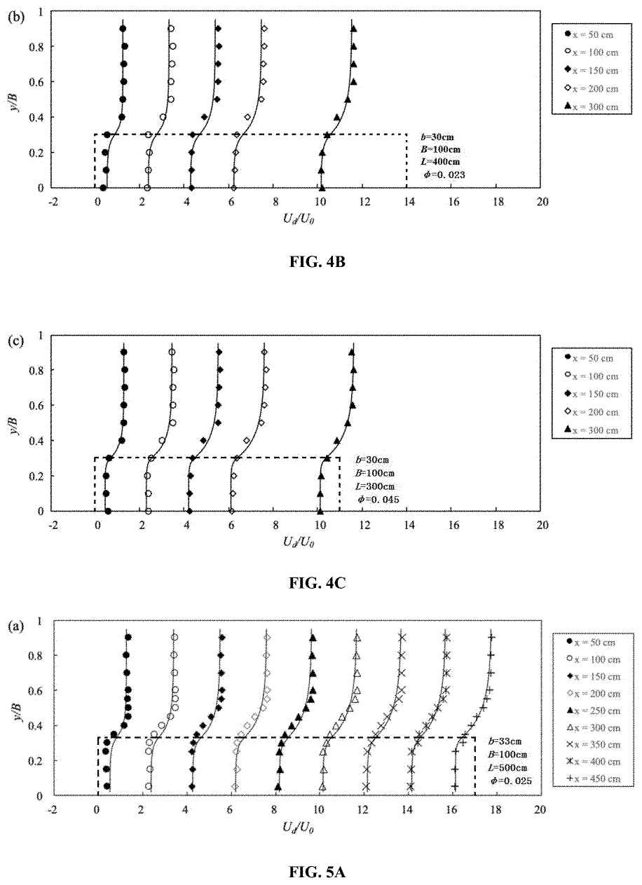

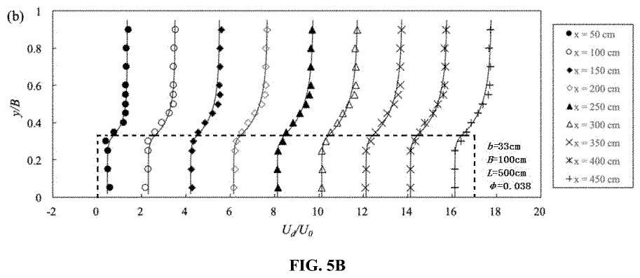

By substituting U_{veg} calculated in the foregoing step into the prediction model in step (2), and then determining U_{y=b} and U_{bare} in step (3), the flow velocity distribution of the two-dimensional flow velocity field in the river channel can be calculated. FIG. 4 shows a flow velocity distribution curve of two-dimensional flow velocity fields in the vegetated region and bare channel under cases B1-B3, and FIG. 5 shows a flow velocity distribution curve of two-dimensional flow fields in the vegetated region and bare channel under cases C1-C2.

V. Analysis of Test Results

In order to quantitatively compare the predicted and measured flow velocities, the Root Mean Square Error (RMSE) is defined as:

$$R M S E = \sqrt{\frac{1}{N} {\sum }_{1}^{N} {( {X}_{p} - {X}_{m} )}^{2}}$$

where N denotes the number of points predicted and measured, and Xₚ and Xₘ denote the predicted and measured flow velocities, respectively.

First, based on the data under cases B1-B3, the predicted flow velocity is compared with the measured flow velocity collected in the center of the flume, as shown in FIG. 4. It can be seen from the figure that the predicted flow velocity exactly matches the measured flow velocity.

Second, as shown in FIG. 5, the model is verified using measurement data under cases C1 and C2, where the vegetation model is located at one side of the flume. It can be seen from the figure that the predicted flow velocity exactly matches the measured flow velocities at different longitudinal positions.

The predicted flow velocity, measured flow velocity, and the ratio of root mean square error to velocity RMSE/U₀ are shown in Table 2.

TABLE 2
Summary table of calculation parameters for each test case

| | | | | | | | | | | | Longitudinal | | RMSE/ |
|---|---|---|---|---|---|---|---|---|---|---|---|---|---|
| | Uₒ | L | b | B | n | a | | Lₗ | δₚ | δₘ | measurement | RMSE | Uₒ |
| Case | (cm/s) | (cm)) | (cm) | (cm) | (cm⁻²) | (cm⁻¹) | ϕ | (cm) | (cm) | (cm) | position, x(cm) | (cm/s) | (%) |
| B1 | 18 | 500 | 40 | 100 | 0.03 | 0.024 | 0.015 | 390 | 20 | 26 | 50, 100, 150, 200, 250, | 2.8 | 16 |
| | | | | | | | | | | | 300, 400, 420 | | |
| B2 | 18 | 400 | 30 | 100 | 0.045 | 0.036 | 0.023 | 330 | 14 | 25.7 | 50, 100, 150, 200, 300 | 2.6 | 14 |
| B3 | 18 | 300 | 30 | 100 | 0.09 | 0.072 | 0.045 | 230 | 7 | 25.5 | 50, 100, 150, 200, 300 | 1.5 | 8 |
| C1 | 16.6 | 500 | 33 | 100 | 0.05 | 0.04 | 0.025 | 330 | 12 | 25.7 | 50, 100, 150, 200, 250, | 2.2 | 13 |
| | | | | | | | | | | | 300, 350, 400, 450 | | |
| C2 | 19.1 | 500 | 33 | 100 | 0.076 | 0.06 | 0.038 | 260 | 8 | 21.1 | 50, 100, 150, 200, 250, | 1.5 | 8 |
| | | | | | | | | | | | 300, 350, 400, 450 | | |

As shown in Table 2, U₀ denotes a mean flow velocity at an upper stream of a river channel; L denotes a length of a vegetation patch; b denotes half width of the vegetation patch under cases B1-B3 or cases C1-C2; B denotes the width of the river channel under cases B1-B3 or cases C1-C2; n denotes cylinder density in the vegetation patch; a(=nd) denotes a frontal area per canopy volume of a single vegetation patch, where d denotes the diameter of a single plant; L_{I} denotes an interior flow adjustment distance of the vegetation, which is defined as the distance between a front edge of the vegetation and a point where the internal velocity of the vegetation reaches the minimum or constant value, which is estimated by measured velocities; δₚ denotes a penetration distance estimated according to measured values; and δₘ denotes a distance of a mixed layer distance estimated according to measured values. RMSE is estimated according to a formula, and calculated based on measured and predicted flow velocities.

As can be seen from Table 2, in all cases, the Root Mean Square Error (RMSE) ranges from 0.4 to 3.1, and the ratio RMSE/U₀ of root mean square error to velocity is between 4% and 16%. The results show that the model of the present disclosure can better predict the two-dimensional flow velocity field of the river channel with partial vegetation.

Those of ordinary skill in the art will understand that the embodiments described herein are intended to help readers understand the principles of the present disclosure, and it should be understood that the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

What is claimed is:

1. An exponential model-based method for predicting a two-dimensional flow velocity field in a river channel with emergent vegetation, comprising the following steps:
(1) with a center of an upstream boundary of an emergent vegetation patch as an origin, dividing the river channel into a vegetated region and a bare channel in a direction perpendicular to a streamwise direction, namely, an x direction, wherein the vegetated region is: 1>y/b>−1, a central area of the vegetated region is: b−δₚ>y>δₚ−b, the bare channel is: B/2≥y≥b and −b≥y≥−B/2, a side edge of the vegetation patch is: y=b, b denotes half width of a vegetation patch, and B denotes half width of a river channel; and δₚ denotes a penetration distance that lateral vortexes penetrate into a patch through its side edge, and δₘ denotes a width of a mixed layer;
(2) determining a model for predicting flow velocity distribution of a two-dimensional flow velocity field in the vegetated region and the bare channel:
wherein a model for the vegetated region is:
$${U}_{d ( 1 )} = {U}_{veg} + ( {U}_{y = b} - {U}_{veg} ) {e}^{\frac{y - b}{{L}_{d ( veg )}}}$$
a model for the bare channel is:
$${U}_{d ( 2 )} = {U}_{bare} + ( {U}_{y = b} - {U}_{bare} ) {e}^{\frac{b - y}{{L}_{d ( bare )}}}$$
wherein U_{d (1)} denotes a laterally distributed flow velocity in a streamwise direction at different locations in the vegetated region, U_{d (2)} denotes a laterally distributed flow velocity in a streamwise direction at different locations in the bare channel, U_{veg} denotes a mean flow velocity over transverse profiles in a streamwise direction of the vegetated region, U_{y=b} denotes a flow velocity at the side edge of the vegetation patch, U_{bare} denotes a mean flow velocity over transverse profiles in a streamwise direction of the bare channel, L_{d (veg)} and L_{d (bare)} denote exponential decay lengths of the vegetated region and the bare channel, respectively, wherein
$$\frac{{L}_{d ( veg )}}{{δ}_{p}} = 0.32 \pm 0.04 , \frac{{L}_{d ( bare )}}{{δ}_{m}} = 0.64 \pm 0.14 ,$$
and the mean flow velocity U_{veg} over transverse profiles in a streamwise direction of the vegetated region can be determined by a model for predicting longitudinal flow velocity distribution in the river channel with an emergent vegetation patch; and
(3) determining the flow velocity U_{y=b} at the side edge of the vegetation patch and the mean flow velocity U_{bare} over transverse profiles in a streamwise direction of the bare channel:
the flow velocity U_{y=b} at the side edge of the vegetation patch and the mean flow velocity U_{bare} over transverse profiles in a streamwise direction of the bare channel are determined according to the following two boundary conditions:
a predicted flow velocity satisfies a flow continuity equation at the side edge of the vegetation patch:
$$\frac{\partial {U}_{veg}}{\partial y} = \frac{\partial {U}_{bare}}{\partial y} ;$$
a predicted flow velocity in the vegetated region and the bare channel satisfies a flow continuity equation: ∫₀^{b}U_{d(1)}dy+∫_{b}^{B}U_{d(2)} dy=BU₀;
wherein U_{d(1)} and U_{d(2)} denote laterally distributed flow velocities in the vegetated region and the bare channel obtained according to the prediction model in step (2), respectively, U₀ denotes a mean flow velocity at an upper stream of the river channel x<−Lᵤ, and Lᵤ denotes a flow deflection distance at an upper stream of the vegetation patch; and
once the flow velocity U_{y=b} at the edge of the vegetation patch and the mean flow velocity U_{bare} over transverse profiles in a streamwise direction of the bare channel are determined, the prediction model in step (2) can be used for predicting flow velocity distribution of the two-dimensional flow velocity field in the vegetated region and the bare channel.

2. The exponential model-based method for predicting a two-dimensional flow velocity field in a river channel with emergent vegetation according to claim 1, wherein in step (2), the mean flow velocity over different transverse profiles in a streamwise direction of the vegetated region is determined according to the following prediction model:
wherein the model for the vegetated region is:
$${U}_{veg} = {U}_{veg ( f )} + ( {U}_{veg ( 0 )} - {U}_{veg ( f )} ) {e}^{\frac{- x}{{L}_{d ( 1 )}}} ;$$
wherein U_{veg} denotes a mean flow velocity over transverse profiles in a streamwise direction of the vegetated region, U_{veg(f)} denotes a mean flow velocity of a fully developed region x>L_{I} within the vegetation patch, U_{veg(0)} denotes a flow velocity at an upstream boundary x=0 of the vegetated region, L_{I} denotes a flow deflection distance within the vegetation patch, L_{d(1)} denotes an exponential decay length within the vegetated region, and L_{d(1)}/L_{I}=0.30±0.01.

3. The exponential model-based method for predicting a two-dimensional flow velocity field in a river channel with emergent vegetation according to claim 2, wherein the flow deflection distance L_{I} within the vegetation patch is determined according to the following formula:
$${L}_{I} = ( 5.5 \pm 0.4 ) \sqrt{{( \frac{2}{{C}_{d} a} )}^{2} + {b}^{2}} ,$$
wherein C_{d} denotes a vegetation drag coefficient, a denotes a frontal area per canopy volume of vegetation per unit water body, and b denotes half width of the vegetation patch.

4. The exponential model-based method for predicting a two-dimensional flow velocity field in a river channel with emergent vegetation according to claim 2, wherein the mean flow velocity U_{veg(f)} of the fully developed region x>L_{I} within the vegetation patch is determined according to the following formula:
$${U}_{veg ( f )} = \sqrt{\frac{g h S}{{C}_{f} + \frac{1 Cd a h}{21 - φ}}} ,$$
wherein g denotes gravitational acceleration; h denotes a water depth; S denotes a water surface slope; and C_{f} denotes a bed friction coefficient.

5. The exponential model-based method for predicting a two-dimensional flow velocity field in a river channel with emergent vegetation according to claim 2, wherein the flow velocity U_{veg(0)} at the upstream boundary of the vegetated region is determined according to the following formula:
U_{veg(0)}/U₀=1−(0.15±0.02)\sqrt{C_{d}ab};
wherein U₀ denotes a mean flow velocity at the upper stream x<−Lᵤ of the river channel, Lᵤ denotes a flow deflection distance at the upper stream of the vegetation patch, C_{d} denotes a vegetation drag coefficient, a denotes a frontal area per canopy volume of vegetation per unit water body, and b denotes half width of the vegetation patch.

6. The exponential model-based method for predicting a two-dimensional flow velocity field in a river channel with emergent vegetation according to claim 1, wherein the mean flow velocity U₀ over transverse profiles at the upper stream x<−Lᵤ of the river channel is determined according to the following formula:
$${U}_{0} = \sqrt{\frac{g h S}{{C}_{f}}}$$
wherein g denotes gravitational acceleration; h denotes a water depth; S denotes a water surface slope; and C_{f} denotes a bed friction coefficient.

7. The exponential model-based method for predicting a two-dimensional flow velocity field in a river channel with emergent vegetation according to claim 1, wherein the flow deflection distance Lᵤ at the upper stream of the vegetation patch is within a range of 30-50 cm.
